(19) United States
(12) Patent Application Publication
(10) Pub. No.: US 2013/0129899 A1
(43) Pub. Date: May 23, 2013

(54) MILK PROTEIN CONTAINING LIQUID BEVERAGE PRODUCTS

(71) Applicants: Madhavi Ummadi, Bakersfield, CA (US); Madansinh Nathusinh Vaghela, Bakersfield, CA (US); Aaron Beth Butterworth, Bakersfield, CA (US); Nirav Chandrakant Pandya, Bakersfield, CA (US); Bridgett Lynn McCune, Bakersfield, CA (US); Christophe Joseph Etienne Schmitt, Servion (CH); Sandhya Sridhar, Dublin, OH (US); Stephen Mark, Dublin, OH (US); Christian Milo, Savigny (CH); Alexander A. Sher, Dublin, OH (US)

(72) Inventors: Madhavi Ummadi, Bakersfield, CA (US); Madansinh Nathusinh Vaghela, Bakersfield, CA (US); Aaron Beth Butterworth, Bakersfield, CA (US); Nirav Chandrakant Pandya, Bakersfield, CA (US); Bridgett Lynn McCune, Bakersfield, CA (US); Christophe Joseph Etienne Schmitt, Servion (CH); Sandhya Sridhar, Dublin, OH (US); Stephen Mark, Dublin, OH (US); Christian Milo, Savigny (CH); Alexander A. Sher, Dublin, OH (US)

(73) Assignee: NESTEC S.A., Vevey (CH)

(21) Appl. No.: 13/813,883

(22) PCT Filed: Aug. 4, 2011
(86) PCT No.: PCT/EP2011/063462

§ 371 Date: Feb. 1, 2013

Related U.S. Application Data
(60) Provisional application No. 61/370,888, filed on Aug. 5, 2010.

(51) Int. Cl. A23L 2/66

(52) U.S. Cl. CPC A23L 2/66
USPC 426/580; 426/590; 426/399

(57) ABSTRACT

The present invention relates to beverage products. In particular, the invention is concerned with a partially denaturated protein system induced by controlled denaturation of milk protein which imparts outstanding sensory attributes on beverage product, in particular when containing low fat. A method of producing such beverage and the products obtainable from the method are also part of the present invention.

### FIELD OF THE INVENTION

The present invention relates to protein containing beverage and the method to produce the same. More specifically, the present disclosure is directed to ready to drink (“RTD”) beverages.

In particular, the invention is concerned with a beverage composition comprising a partially denatured protein system which contributes to the improvement of textural and sensorial attributes of the beverages composition including products based on lower fat.

A method of producing such beverages and the products obtainable from the method are also part of the present invention.

### BACKGROUND OF THE INVENTION

Many technical routes have been explored in the prior art to improve the sensorial properties of food and beverages

There is a need for beverage products having an improved the sensory profile in order to achieve a pleasant taste, texture and aroma and delivering the beneficial effects associated with a denatured protein system.

### SUMMARY OF THE INVENTION

The present invention now solves the foregoing problems by providing a stable beverage composition having enhanced or improved organoleptic properties.

In a first aspect, the invention relates to a beverage composition comprising a partially denaturated protein system including kappa-casein and beta-lactoglobulin, said product having a pH comprised between 5.6 and 6.3, preferably between 5.8 and 6.3.

Preferably, the product of the invention is characterised by a content of soluble protein below or equal to 60%, a ratio of soluble kappa-casein to total content of kappa-casein below or equal to 0.12 and a ratio of soluble beta-lactoglobulin to total content of beta-lactoglobulin below or equal to 0.57.

In a preferred aspect of the invention the beverage composition according to the invention is a milk protein containing liquid Beverages

The products of the invention present excellent organoleptic properties, in particular in terms of texture and mouthfeel even when very low levels of fat are used. Besides, the products of the invention show good stability and can therefore advantageously allow avoiding the use of non-natural additives.

In a further aspect, the invention pertains to the use of a partially denaturated protein system comprising kappa-casein and beta-lactoglobulin for manufacturing a protein containing beverage.

The invention also relates to a method of producing a beverage wherein controlled heat and acidic conditions are applied to said beverage in such a way to provide a partially denaturated protein system.

In another embodiment the invention relates to a method of producing a beverage product particularly a ready to drink (“RTD”) beverage comprising the steps of
a) providing an ingredient composition (beverage composition comprising milk solids non-fat, sweetening agent, optional stabilizer system, flavors, optional cocoa, optional colorants, and acidic component) with a pH comprised between 5.6 and 6.3, preferably between 5.8 and 6.3, wherein the proteins content is preferably in an amount of 0.5 to 10% by weight, and an acidic component (Such as citric acid or phosphoric acid);
b) Heat treating of the above composition at 68 to 93° C. for 3 to 90 minutes
c) Optionally adding other ingredients after the step b such as fat, preferably in an amount of 0 to 10% by weight, a sweetening agent, preferably in an amount of 0 to 30%, a stabiliser system, preferably in an amount of 0 to 2% and colorants, flavors, vitamins, minerals or other functional ingredients.
d) Homogenising the liquid beverage using a one or two stage high pressure homogenizer
e) Pasteurising (73 to 80° C. for 15 seconds), Sterilizing (UHT at 136-150° C. for 3 to 15 second or retorting at 121° C. for 5 minutes (or equivalent)) the final beverage
f) Filling either aseptically for UHT in flexible cartons or PET or similar containers, or filling before retorting for canned beverages.

In a preferred embodiment the invention relates to a method of producing a Milk protein containing liquid Beverages particularly a Milk protein containing ready to drink (“RTD”) beverage

In another embodiment the beverage composition of the invention is a beverage concentrate. In such embodiment the levels of the ingredients should be proportionally increased according to the degree of concentration.

The products obtainable by these methods or the use mentioned above also form an embodiment of the present invention.

In the beverages products of the invention, and particularly in a milk protein containing liquid Beverages of the invention the partially denaturated protein system preferably includes milk proteins, caseins, whey proteins or mixtures thereof that have been denaturated by a heat treatment in an acidic environment e.g. through the presence of molasses or of an organic acid. More particularly, the partially denaturated protein system of the products of the invention includes kappa-casein and beta-lactoglobulin in the form of complexes or aggregates. The partially denaturated protein system is generally present in an amount sufficient to provide a smooth and creamy texture to the beverage product to which it is added or in which it is formed without the use of non-natural stabilizers or other conventional artificial additives used for this purpose.

### DETAILED DESCRIPTION OF THE INVENTION

The invention as described in the claims relates to:
1. A beverage product comprising a partially denaturated protein system including kappa-casein and beta-lactoglobulin, wherein said product has a pH comprised between 5.6 and 6.3, preferably between 5.8 and 6.3.
2. A product according to claim 1 wherein, the content of soluble protein is below or equal to 60%, the ratio of soluble kappa-casein to total content of kappa-casein is below or equal to 0.12 and the ratio of soluble beta-lactoglobulin to total content of beta-lactoglobulin is equal or below 0.57.
3. Product according to claim 1 or 2, comprising 0 to 10% by weight of fat, 0.5 to 10% by weight of protein, 0 to 30% by weight of sweetening agent, and a stabiliser system including an emulsifier, in an amount of 0 to 1% by weight.
4. Product according to any of the preceding claims, characterized in that it is essentially or completely free of any artificial or non-natural emulsifier or stabilizer.
5. Product according to any of the preceding claims characterised in that it is a ready to drink beverage.
Product according to any of the preceding claims characterised in that it is a milk protein containing liquid Beverages
6. Product according to any of the preceding claims characterised in that it is a dairy liquid Beverages
7. A method of producing a beverage comprising the steps of:
   a) providing an ingredient mix comprising a protein system including kappa-casein and beta-lactoglobulin, with a pH comprised between 5.6 and 6.3, preferably between 5.8 and 6.3 and comprising 0.5 to 10% proteins by weight and an acidic component, and further optionally comprising fat, preferably in an amount of 0 to 10% by weight, optionally comprising a sweetening agent, preferably in an amount of 0 to 30% by weight, optionally comprising a stabiliser system, preferably in an amount of 0 to 1% by weight;
   b) the heat treating at 68-93° C. for 3-90 minutes;
   c) homogenising the beverage;
   d) Pasteurising at 73-80° C. for 15 seconds, or sterilizing at UHT conditions at 136-150 ° C. for 3-15 seconds, or retorting at 121° C. for 5 minutes or equivalent;
   e) Filling either aseptically for UHT beverages in flexible cartons or PET or similar containers, or filling before retorting for canned beverages.
8. Method according to claim 9, wherein the ingredient mix comprises an acidic component selected from liquid molasses, an organic acid such as citric acid, an inorganic acid such as phosphoric acid, fruit derived acids or fermentation derived acids.
9. Beverage product obtainable by the method of any one of claims 5 to 6.
15 8. Use of a partially denaturated protein system comprising kappa-casein and beta-lactoglobulin for manufacturing a beverage product.

In the following description, the % values are in wt % unless otherwise specified.

The invention pertains to protein containing beverage, more particularly to milk protein containing liquid Beverages which texture and mouthfeel are improved as a result of an optimized process of preparation including the controlled use of heat and acidic conditions.

In a first aspect, the invention relates to a protein containing beverage comprising a partially denaturated protein system including kappa-casein and beta-lactoglobulin, wherein said product has a pH comprised between 5.6 and 6.3, preferably between 5.8 and 6.3. Preferably, the product is characterised by a protein content in soluble phase below or equal to 60%, a ratio of soluble kappa-casein to total content of kappa-casein below or equal to 0.12 and a ratio of beta-lactoglobulin to total content of beta-lactoglobulin below or equal to 0.57.

What is meant by “soluble protein”, “soluble kappa-casein” or yet “soluble beta-lactoglobulin” is the amount of corresponding protein in the soluble fraction of the beverage composition.

### Liquid Beverage Composition and Product

A beverage composition according to the invention may be any beverage composition, meant to be consumed by a human or animal, such as e.g. a beverage, e.g. a coffee beverage, a cocoa or chocolate beverage, a malted beverage, a fruit or juice beverage, a carbonated beverage, a soft drink, or a milk based beverage; a performance nutrition product, powder or ready-to-drink beverage; a medical nutrition product; a dairy product, e.g. a milk drink, a yogurt or other fermented dairy product; a product for improving mental performance or preventing mental decline, or a skin improving product.

### Beverage or Beverage Composition

A beverage according to the invention may e.g. be in the form of liquid or liquid concentrate to be mixed with a suitable liquid, e.g. water or milk, before consumption, or a ready-to-drink beverage. By a ready-to-drink beverage is meant a beverage in liquid form ready to be consumed without further addition of liquid. A beverage according to the invention may comprise any other suitable ingredients known in the art for producing a beverage, such as e.g. sweeteners, e.g. sugar, such as invert sugar, sucrose, fructose, glucose, or any mixture thereof, natural or artificial sweetener; aromas and flavors, e.g. fruit, cola, coffee, or tea aroma and/or flavor; fruit or vegetable juice or puree; milk; stabilizers; emulsifiers; natural or artificial color; preservatives; antioxidants, e.g. ascorbic acid; and the like.

Any suitable acid or base may be used to achieve a desired pH of the product, e.g. citric acid or phosphoric acid. A beverage of the invention may be carbonated; carbon dioxide may be added by any suitable method known in the art. In a preferred embodiment a beverage comprises up to 10% sucrose or another sweetener in an amount yielding an equal degree of sweetness, more preferably between 2% and 5% sucrose or another sweetener in an amount yielding an equal degree of sweetness. If the beverage is a liquid concentrate or a ready-to-drink beverage it may be subjected to a heat treatment to increase the shelf life or the product, e.g. by retorting, UHT (Ultra High Temperature) treatment, HTST (High Temperature Short Time) pasteurization, batch pasteurization, or hot fill.

Milk protein containing liquid Beverages are

Beverages or beverage concentrates containing milk (e.g. fluid, fat-removed, lactose-removed, powder, concentrate, fractionated) or the proteins obtained, whether native or modified, from milk, or a mixture thereof.

The products of the invention are characterised by the presence of a partially denatured protein system.

The term “partially denatured protein system” is to be understood to mean a complex or an aggregate resulting from at least a partial coagulation of proteins present in the ingredient mix, for instance induced by the presence of an acid component combined with a heat treatment for the specific time. The denaturation process involves an unfolding or at least an alteration in the 3D structure of the proteins. The term denaturation refers to the response of the protein to any of the agents that cause changes in the protein structure. Such agents can include heat, acid, alkali, and a variety of other chemical and physical agents.

The term “partially denaturated protein system” is to be understood to mean a complex or an aggregate resulting from at least a partial denaturation of proteins present in the ingredient mix, for instance induced by the presence of an acid component combined with a heat treatment.

Most milk proteins (mainly caseins) in their native state remain in colloidal suspension form leading to minimal changes to mix viscosity (˜200-400 cp). However, when proteins are subjected to controlled exposure to known amounts of heat and acid (e.g., pH of 6.1 or less and pasteurization) they undergo denaturation. Denaturation is a state where the proteins are hydrated resulting in a three dimensional network (soft gel) causing increased mix viscosity (˜1800-2400 cp). If the exposure of proteins to heat and acid is not controlled, this phenomenon could lead to precipitation (e.g., syneresis in yogurt). In the worst case scenario, the liquid separates from the precipitate and the size of the solids decreases.

The partially denaturated protein system according to the invention is characterised by the presence of a significant particle size peak or group of particles greater than 45 μm, preferably greater than 100 μm, and lower than 300 μm. A more preferred range is 125 μm to 250 μm.

The applicant has discovered that texture and mouthfeel of beverage product more particularly of ready to drink (“RTD”) beverage is improved as a result of an optimized process of preparation including the controlled use of heat and acidic conditions and time. More particularly, by manipulating the protein structure by decreasing the pH and exposing the mix to controlled heat for a specific time, it is believed that protein denaturation and subsequent aggregation occurs as heat at these conditions changes the protein structure. These proteins form aggregates that create a uniquely smooth, creamy texture that improves the body and mouthfeel. It is believed that protein denaturation and subsequent aggregation occurs as heat unfolds whey protein and acidic conditions destabilize casein micelles. These protein aggregates form a network that is suspected of increasing creaminess and mouthfeel that mimics the presence of higher fat levels.

The present invention thus relates in a first aspect to a beverage product more particularly a ready to drink (“RTD”) beverage comprising a partially denatured protein system. More particularly the present invention relates to milk protein containing (“RTD”) beverages

The present invention thus relates in a first aspect to a beverage comprising a partially denaturated protein system including kappa-casein and beta-lactoglobulin. The products of the invention are characterised by a pH comprised in a range of 5.6 to 6.3, preferably 5.8 to 6.3. Preferably, the total content of protein in the soluble fraction is below or equal to 60%, the ratio of soluble kappa-casein to total kappa-casein is below or equal to 0.12 and the ratio of soluble beta-lactoglobulin to total content of beta-lactoglobulin is below or equal 0.57 when the beverage is centrifuged at 50'000 g for 30 min.

The products of the invention comprise protein complexes formed between mainly beta-lactoglobulin and the kappa-casein from the surface of the casein micelles. The major milk proteins can be detected among which beta-lactoglobulin and kappa-casein. The process described in the invention is leading to the formation of covalent complexes (probably linked by disulphide bonds) between kappa-casein and beta-lactoglobulin and that these complexes are more numerous in the control sample (higher initial kappa-casein band density). Without being bound by theory, it is believed that casein micelles are coated with beta-lactoglobulin under the acidic conditions of our invention and are either entrapped in the fat phase or in the insoluble phase after centrifugation, leading to a depletion of the protein aggregates in the soluble phase. The soluble aggregates are mainly composed of beta-lactoglobulin and kappa-casein complexes that did not adsorb with the casein micelles to the fat droplet interface during beverage manufacture or were not sensitive to centrifugation, but remained in the bulk phase. The partially denaturated protein system of the invention therefore consists on the one hand in casein micelles/whey protein complexes which can be defined as covalent protein aggregates formed between the kappa-casein from the surface of the casein micelles and mostly in soluble kappa-casein/beta-lactoglobulin complexes present in the beverage. The products of the invention are characterised by a ratio of soluble kappa-casein to total amount of kappa-casein below or equal to 0.12 and a ratio of soluble beta-lactoglobulin to total content of beta-lactoglobulin below or equal to 0.57 when the products are centrifuged at 50'000 g for 30 min.

The amount of kappa-casein and beta-lactoglobulin can be measured from Coomassie Blue gel electrophoresis analysis. The content of these two proteins can be determined from analysis of the intensity of the corresponding migration bands on reduced electrophoresis Nu-PAGE gels.

### Method:

For total sample, an aliquot of 10 g of beverage according to the invention was dispersed in 90 g of a deflocculating aqueous solution at pH 9.5 containing 0.4% EDTA and 0.1% Tween 20. The soluble phase was obtained by centrifugation of the beverage at 50,000 g for 30 min. Samples were then analyzed by gel electrophoresis on Nu-PAGE 12% Bis-Tris using the MOPS running buffer in reducing and non-reducing conditions (reducing conditions should break any covalent bound involving SH/SS exchange during heating) as described in “Invitrogen Nu-PAGE pre-cast gels instructions” (5791 Van Allen Way, Carlsbad, Calif. 2008, USA). Gels were stained with Coomassie blue (Invitrogen kit no. LC6025). The total sample and the corresponding soluble phase were deposited on the same electrophoresis gel at a concentration of 0.5 mg·mL⁻¹. After migration and staining with colloidal blue, the gels were scanned in 256 gray levels with a resolution of 1000 dpi using a UMAX scanner coupled with the MagicScan 32 V4.6 software (UMAX Data Systems, Inc.) leading to pictures having a size of 16 MB. These pictures were then analyzed using the TotalLab TL120 v2008.01 image analysis software (Nonlinear Dynamics Ltd, Cuthbert House, All Saints, Newcastle upon Tyne, NE1 2ET, UK). Migration lanes were detected automatically by the software. Then, image was corrected for background using the “rolling ball” option with a radius of 200. Protein bands corresponding to bovine serum albumin (BSA), β-casein, αs1- and αs2-casein, κ-casein, β-lactoglobulin (β-lg) and α-lactalbumin (α-la) were detected manually using the migration bands from a skimmed milk as a standard. The intensity of the bands was converted into peak migration profiles for each migration lane for the total sample and the soluble phase. These peaks were then fitted with a Gaussian model in order to calculate their area for each protein, and thereby the concentration of the protein in the sample.

The peak area determined for a protein in the soluble phase was thereafter corrected by the effective protein content determined by the Kjeldahl method (described thereafter) and normalised by the peak area of the corresponding protein in the total sample, leading to soluble β-lactoglobulin and κ-casein ratios that are specific to the products obtained according to the invention.

The invention is also characterised by the fact that when centrifuged at 50'000g for 30 min, the ratio of soluble protein to total protein is below 60%.

The amount of proteins present in the soluble phase after centrifugation can be measured by Kjeldahl method using a conversion factor of 6.38 for milk proteins.

### Kjeldahl Method:

Kjeldahl is a general method allowing the determination of total nitrogen, using a block-digestion apparatus and automated steam distillation unit.

This method is applicable to a wide range of products, including dairy products, cereals, confectionary, meat products, pet food, as well as ingredients containing low levels of protein, such as starches. Nitrogen from nitrates and nitrites is not determined with this method.

This method correspond to the following official methods: ISO 8968-1/IDF 20-1 (milk), AOAC 991.20 (milk), AOAC 979.09 (grains), AOAC 981.10 (meat), AOAC 976.05 (animal feed and pet food), with small modifications (adaptation of catalyst quantity and sulphuric acid volume for digestion, and adaptation of boric acid concentration for automated system).

Principle of the method: Rapid mineralisation of the sample at about 370° C. with sulfuric acid and Missouri catalyst, a mixture of copper, sodium and/or potassium sulfate, which transforms organically bound nitrogen to ammonium sulfate. Release of ammonia by addition of sodium hydroxide. Steam distillation and collection of the distillate in boric acid solution. Acidimetric titration of ammonium.

Apparatus: Mineralization and distillation unit in combination with a titration unit.

Manual, semi-automated and automated conformations are possible.

These methods are known from a skilled person in the art of beverage manufacture who has a good knowledge of proteins.

The products of the invention have a pH comprised between 5.6 and 6.3, preferably between 5.8 and 6.3. When the protein system is essentially completely denaturated prior to addition to the other components, the pH can be as high as about 6.3 without detracting from the organoleptic properties of the product.

According to a particular embodiment, the pH is controlled by the presence of an acidic component. The acidic component is preferably selected from the group consisting of molasses, an organic acid such as citric acid, an inorganic acid such as phosphoric acid, fruit derived acids and fermentation derived acids.

According to a particular embodiment, the product according to the invention comprises 0 to 10% fat, 0.5 to 10% protein and 0 to 30%, of a sweetening agent and a stabilizer in an amount of 0 to 1%.

By “sweetening agent” it is to be understood a mixture of ingredients which imparts sweetness to the final product. These include natural sugars like cane sugar, beet sugar, molasses, other plant derived nutritive and non-nutritive sweeteners, and chemically synthesized non-nutritive high intensity sweeteners.

The reduction of fat in beverages without compromising the indulgent quality of the product is one of the main challenges faced by the industry. The present invention is overcoming this issue in providing low fat or even non-fat products with similar texture and sensory attributes than those having higher fat contents in terms of creaminess and mouthfeel.

According to a specific embodiment, the product of the invention essentially consists in natural ingredients.

By “natural ingredients” what is meant are ingredients of natural origin. These include ingredients which come directly from the field, animals, etc. or which are the result of a physical or microbiological/enzymatic transformation process. These therefore do not include ingredients which are the result of a chemical modification process.

Examples of non-natural ingredients which are avoided in this particular embodiment of the invention include for example mono- and diglycerides of fatty acids, acid esters of mono- and diglycerides of fatty acids such as acetic, lactic, citric, tartaric, mono- and diacetyl tartaric acid esters of mono- and diglycerides of fatty acids, mixed acetic and tartaric acid esters of mono- and diglycerides of fatty acids, sucrose esters of fatty acids, polyglycerol esters of fatty acids, polyglycerol polyricinoleate, polyethylene sorbitan mono-oleate, polysorbate 80, chemically extracted lecithin.

Chemically modified starches which are used in the art as stabilisers are also preferably avoided. These include for example oxidised starch, monostarch phosphate, distarch phosphate, phosphated or acetylated distarch phosphate, acetylated starch, acetylated distarch afipate, hydroxy propyl starch, hydroxypropyl distarch phosphate, acetylated oxidised starch.

The products of the invention are preferably essentially free of the preceding synthetic esters and modified starches. “Essentially free” means that these materials are not intentionally added for their conventional property imparting abilities, e.g., stabilizing, although there could be unintended minor amounts present without detracting from the performance of the products. Generally and preferably, the products of the invention will not contain any non-natural materials.

The products may thus include a stabilizer system.

A “stabilizer system” is to be understood as a mixture of ingredients which contributes to the stability of the beverage product with respect to shelf life, overall texture properties etc. Thus, the stabilizer system may comprise any ingredients which are of physical and functional importance to the beverage.

The stabilizer system that may be used in the present products preferably comprises at least one natural emulsifier.

Natural emulsifiers include for example egg yolk, buttermilk, raw acacia gum, rice bran extract or mixtures thereof. The natural emulsifiers have the advantage of conferring to the finished product improved texture and mouthfeel.

According to another particular embodiment, the stabilizer system used in the products of the invention comprises at least one non-natural emulsifier. Any food grade emulsifier typically used in beverage could be used. suitable emulsifiers include sugar esters, emulsifying waxes such as beeswax, carnauba wax, candedilla wax, plant or fruit waxes and animal waxes, polyglycerol fatty acid esters, polyglycerol polyricinoleate (PGPR), polysorbates (polyoxyethylene sorbitan esters), monoglycerides, diglycerides, lecithin and mixtures thereof.

The product may additionally comprise flavors or colorants. These are used in conventional amounts which can be optimized by routine testing for any particular product formulation.

It has been surprisingly found out that the presence of this partially denaturated protein system in a beverage according to the invention improves the sensory profile of the product and in particular that it enhances considerably the smooth and creamy texture of said beverage that contains this system.

The present invention is directed to a partially denaturated protein system produced between an acidic component and proteins such as milk proteins, which has shown to considerably improve the beverage of the invention.

Furthermore, the product of the invention has proven to be particularly stable, both when refrigerated as well as when kept at room temperature for consumption.

The invention relates in a further aspect to the use of a partially denaturated protein system including kappa-casein and beta-lactoglobulin for manufacturing a beverage with a pH comprised between 5.6 and 6.3, preferably between 5.8 and 6.3.

Such a system offers the unexpected advantage that it can confer to the beverage product exceptional sensory attributes with good stability while minimizing the fat content.

Preferably the partially denaturated system comprises complexes of beta-lactoglobulin and kappa-casein from the surface of casein micelles which have a particle size of 45 μm, preferably greater than 100 μm, and lower than 300 μm, e.g. 125 μm to 250 μm.

In one aspect the invention deals with a method of producing a beverage comprising the steps of:
a) providing a beverage composition with a pH comprised between 5.6 and 6.3, preferably between 5.8 and 6.3 and comprising 0.5 to 10% proteins by weight and an acidic component, and further optionally comprising fat, preferably in an amount of 0 to 10% by weight, optionally comprising a sweetening agent, preferably in an amount of 0 to 30% by weight, optionally comprising a stabilizer system, preferably in an amount of 0 to 1% by weight;
b) the heat treating at 68-93° C. for 3-90 minutes;
c) homogenizing the beverage;
d) Pasteurizing at 73-80° C. for 15 seconds, or sterilizing at UHT conditions at 136-150° C. for 3-15 seconds, or retorting at 121° C. for 5 minutes (or equivalent);
e) Filling either aseptically for UHT beverages in flexible carton or PET or similar containers, or filling before retorting for canned beverages.

The process of the invention has surprisingly proven to enhance the textural experience of beverages according to the invention even at lower fat. The applicant has discovered that the controlled reduction of the pH of the composition before pasterurization, sterilization or retorting results in a product with smooth, creamy texture and superior flavor release when compared to typical beverage products.

According to a particular embodiment, the beverage according to the invention comprises an acidic component. Preferably the acid component is selected from the group consisting of molasses, an organic acid such as citric acid, an inorganic acid such as phosphoric acid, fruit derived acids and fermentation derived acids.

The method of the invention lends itself to the manufacture of beverages according to the invention which are shelf-life stable at the necessary storage temperatures and have superior organoleptic and textural properties.

### EXAMPLES

The present invention is illustrated further herein by the following non-limiting examples.

### Example 1

### Flavored Milk Beverage

TABLE 1

| | Wt % of final |
|---|---|
| Ingredient | product |
| Fat | 1.0 |
| Sugar | 8.0 |
| NFDM | 9.0 |
| Hydrocolloid | 0.02 |
| stabilizer | |
| Flavouring | 0.2 |
| Cocoa Powder | 1.0 |

In a first variable, referred to as “Control 1”, conventional beverage making procedures were followed: in tank containing 900 g of water, 10 g of fat, 80 g of sugar, 90 g of non-fat dry milk, 3 g of hydrocolloid stabilizer (Carrageenan), 2 g of flavor and 10 g of cocoa powder under agitation and rest of water to achieve 1000 g of liquid. The liquid was pasteurised at 88° C. for 25 seconds and then homogenized at total pressure of 170 bars.

In a second variable a similar composition was prepared but with addition of citric acid to lower the pH to 6.1 before pasteurization. The liquid was then pre-heat treated at 77° C. for 3 minutes. Then the liquid was pasteurised at 88° C. for 25 seconds and then homogenized at total pressure of 170 bars.

The RTD beverage made with the controlled reduction in pH using citric acid, pre heat treated at the specified time and temperature was significantly smoother and improved texture compared to “Control 1”.

### Example 2

### Flavored Milk Beverage

TABLE 1

| | Wt % of final |
|---|---|
| Ingredient | product |
| Fat | 1.0 |
| Sugar | 8.0 |
| NFDM | 9.0 |
| Hydrocolloid | 0.02 |
| stabilizer | |
| Flavouring | 0.2 |
| Cocoa Powder | 1.0 |

In a first variable, referred to as “Control 2”, conventional beverage making procedures were followed: in tank containing 900 g of water, 10 g of fat, 80 g of sugar, 90 g of non-fat dry milk, 3 g of hydrocolloid stabilizer (Carrageenan), 2 g of flavor and 10 g of cocoa powder under agitation and rest of water to achieve 1000 g of liquid. The liquid was then pre-heat treated at 77° C. for 3 minutes. Then the liquid was pasteurized at 88° C. for 25 seconds and then homogenized at total pressure of 170 bars.

In a second variable a similar composition was prepared but with addition of phosphoric acid to lower the pH to 6.1 before pasteurization. The liquid was then pre-heat treated at 77° C. for 3 minutes. Then the liquid was pasteurised at 88° C. for 25 seconds and then homogenized at total pressure of 170 bars.

The RTD beverage made with the controlled reduction in pH using phosphoric acid, pre heat treated at the specified time and temperature was significantly smoother and improved texture compared to “Control 2”.

1. A beverage product comprising a partially denaturated protein system including kappa-casein and beta-lactoglobulin, the product has a pH of between 5.6 and 6.3.

2. A product according to claim 1 wherein, the content of soluble protein is not greater than 60%, the ratio of soluble kappa-casein to total content of kappa-casein is not greater than 0.12 and the ratio of soluble beta-lactoglobulin to total content of beta-lactoglobulin is not greater than 0.57.

3. Product according to claim 1, comprising 0 to 10% by weight of fat, 0.5 to 10% by weight of protein, 0 to 30% by weight of sweetening agent, and a stabilizer system including an emulsifier, in an amount of 0 to 1% by weight.

4. Product according to claim 1, wherein it is essentially or completely free of any artificial or non-natural emulsifier or stabilizer.

5. Product according to claim 1, wherein it is a ready to drink beverage.

6. Product according to claim 1, wherein it is a milk protein containing liquid beverage.

7. Product according to claim 1, wherein it is a dairy liquid beverage.

8. A method of producing a beverage comprising the steps of:
providing an ingredient mix comprising a protein system including kappa-casein and beta-lactoglobulin, with a pH of between 5.6 and 6.3 and comprising 0.5 to 10% proteins by weight and an acidic component;
the heat treating the mix at 68-93° C. for 3-90 minutes;
homogenizing the beverage;
subjecting the beverage to a treatment selected from the group consisting of pasteurizing at 73-80° C. for 15 seconds, or sterilizing at UHT conditions at 136-150° C. for 3-15 seconds, and retorting at 121° C. for 5 minutes; and
filling either aseptically for UHT beverages in flexible cartons or PET or similar containers, or filling before retorting for canned beverages.

9. Method according to claim 8, wherein the ingredient mix comprises an acidic component selected from the group consisting of liquid molasses, an organic acid, an inorganic acid, fruit derived acids and fermentation derived acids.

10. Beverage product obtained by the method of claim 8.

11. A method for manufacturing a beverage product comprising the step of using a partially denaturated protein system comprising kappa-casein and beta-lactoglobulin to produce the product.
